(19) United States
(12) Patent Application Publication
(10) Pub. No.: US 2005/0039338 A1
(43) Pub. Date: Feb. 24, 2005

(54) Pivotable shaving cartridge and razor including same

(75) Inventors: Brian F. King, Orange, CT (US); John F. Pacilio, West Haven, CT (US)

Correspondence Address: MCCORMICK, PAULDING & HUBER LLP, CITY PLACE II, 185 ASYLUM STREET, HARTFORD, CT, 06103, US

(73) Assignee: Eveready Battery Company, Inc., St. Louis, MO (US)

(21) Appl. No.: 10/886,971

(22) Filed: Jul. 7, 2004

Related U.S. Application Data
(60) Provisional application No. 60/485,311, filed on Jul. 7, 2003.

(51) Int. Cl. B26B 21/00

(52) U.S. Cl. 30/346.5; 30/50

(57) ABSTRACT

A blade cartridge for a wet shaving device and razor assembly incorporating the blade cartridge comprises a handle including a cartridge end having first and second arms spaced from one another. Each of the arms includes first and second projections. A razor cartridge includes a housing including first and second side portions, and a frame extending between the first and second side portions. At least one blade is supported by the frame and extends generally between the first and second side portions. Each of the first and second side portions has an outwardly facing surface defining an opening for pivotably receiving an associated first projection of the razor handle, and a curved channel for slidably receiving an associated second projection of the razor handle to permit pivoting of the cartridge relative to the handle.

### CROSS REFERENCE TO RELATED APPLICATIONS AND PATENTS

This application is entitled to the benefit of and incorporates by reference the disclosure of U.S. Patent Application Ser. No. 60/485,311 filed on Jul. 7, 2003 entitled “Pivotable Shaving Cartridge and Razor Including Same”; the disclosure of U.S. Pat. No. 6,138,361 issued on Oct. 31, 2000 entitled “Pivotable Razor Assembly and Cartridge”; and the disclosure of U.S. Pat. No. 6,182,366 B1 issued on Feb. 6, 2001 entitled “Flexible Razor Assembly and Cartridge.

### FIELD OF THE INVENTION

This invention relates generally to cartridges used in wet shave razors, and more particularly to the manner.

### BACKGROUND OF THE INVENTION

Razor assemblies are known which include a razor cartridge that is pivotable relative to a razor handle. Pivotable razor assemblies typically include a component of the handle which engages an interior portion of the razor cartridge. For example, pivotable razors are known to include a clam shell pivot arrangement in which a handle assembly having curved journal members pivotably engages curved journalled end members of the cartridge at an interior location of the cartridge. Pivotably coupling the handle to the cartridge at an interior location of the cartridge increases the possibility of interference of the internal components of the cartridge with the pivoting mechanism. Moreover, pivotably coupling the handle to the cartridge at an interior location of the cartridge encroaches upon a portion of the space that can be used to define a rinse channel.

In response to the foregoing, it is an object of the present invention to improve upon or overcome the drawbacks and disadvantages of prior art pivotable wet shaving devices.

### SUMMARY OF THE INVENTION

In a first aspect of the present invention, a razor cartridge comprises a housing including first and second side portions. A frame extends between the first and second side portions. At least one blade is supported by the frame and extends generally between the first and second side portions. Each of the first and second side portions has an outwardly facing surface defining an opening for pivotably receiving an associated first projection of a razor handle, and a curved channel for slidably receiving an associated second projection of a razor handle to permit pivoting of the cartridge relative to the handle.

In a second aspect of the present invention, a razor assembly comprises a handle including a cartridge end having first and second arms spaced from one another. Each of the arms includes first and second projections. A razor cartridge is coupled to the cartridge end of the handle. The razor cartridge includes a housing including first and second side portions, and a frame extending between the first and second side portions. At least one blade is supported by the frame and extends generally between the first and second side portions. Each of the first and second side portions has an outwardly facing surface defining an opening for pivotably receiving an associated first projection of the razor handle, and a curved channel for slidably receiving an associated second projection of the razor handle to permit pivoting of the cartridge relative to the handle. Preferably, the razor assembly further includes a biasing member coupled at one end to the handle and at another end to the cartridge to urge the cartridge toward a neutral pivot position relative to the handle.

Coupling the first and second arms to an external surface of the cartridge, instead of an internal surface, eliminates possible interference between the internal components of the cartridge and the first and second arms which could otherwise impede pivoting of the cartridge. The elimination of interference also permits greater flexibility in selecting at the design stage the location of a pivot axis of the cartridge relative to the handle. Moreover, coupling the first and second arms to an external surface of the cartridge permits a larger channel to be defined by the cartridge for rinsing debris therefrom.

### BRIEF DESCRIPTION OF THE DRAWINGS

FIG. 1 is a partial perspective view of a razor assembly embodying the present invention.

FIG. 2 is a partial perspective view of the cartridge of the razor assembly of FIG. 1.

FIG. 3 is a partial perspective view of the razor assembly of FIG. 1 with the cartridge removed.

FIG. 4 is a partial perspective view of a razor assembly in accordance with a second embodiment of the present invention.

### DETAILED DESCRIPTION OF THE PREFERRED EMBODIMENTS

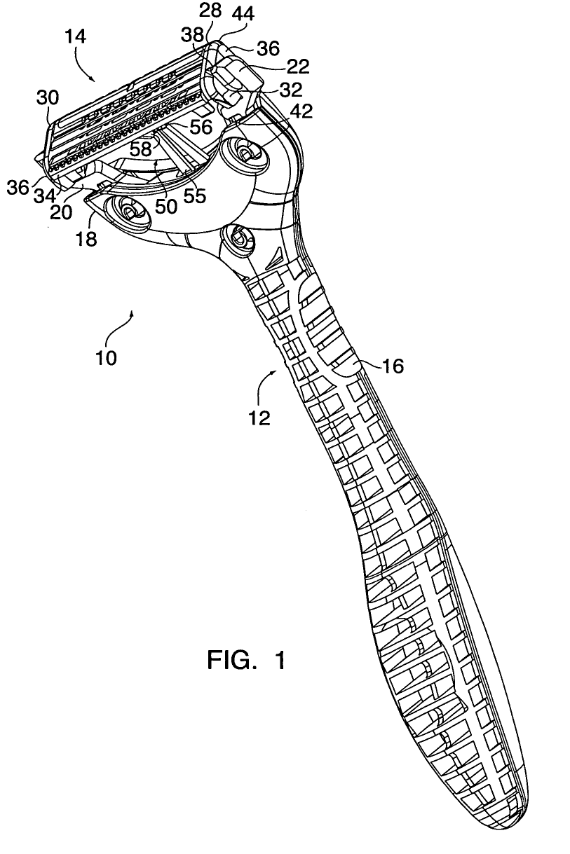

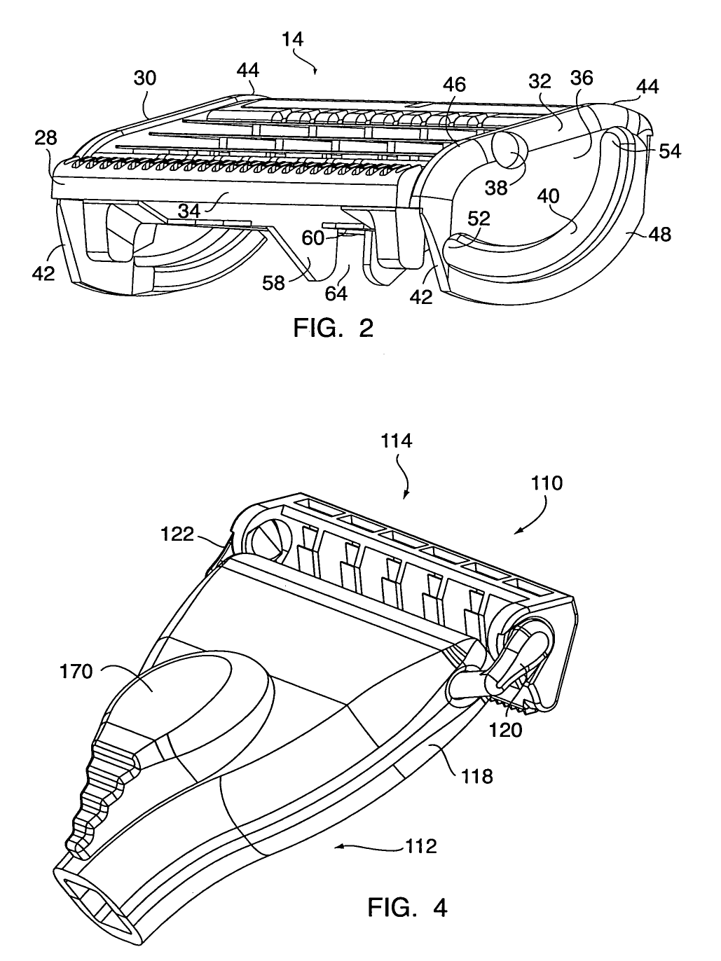

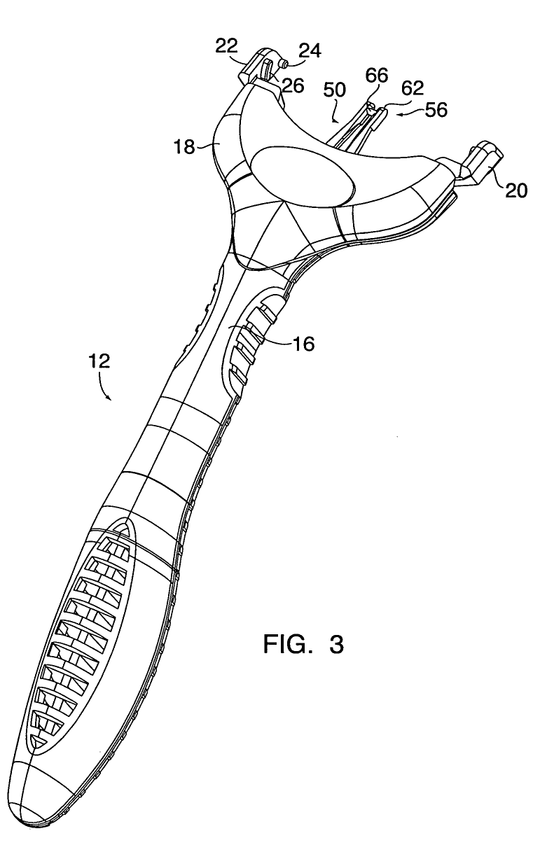

With reference to FIGS. 1-3, a razor assembly embodying the present invention is designated generally by the reference number 10. The razor assembly 10 includes a handle 12 and a razor cartridge 14 pivotably coupled to the handle. The razor assembly 10 can be either a disposable assembly or a permanent assembly without departing from the scope of the present invention.

The handle 12 includes a grip end 16 and a cartridge end 18 for being coupled to the razor cartridge 14. The cartridge end 18 of the handle 12 includes first and second arms 20, 22 laterally spaced from one another and extending in a direction generally away relative to the grip end 16 of the handle when the handle is coupled to the razor cartridge 14. Each of the first and second arms 20, 22 preferably includes first and second projections 24, 26 extending laterally inwardly relative to the grip end 16 for pivotably engaging the razor cartridge 14 as explained more fully below.

The razor cartridge 14 includes a housing 28 defining first and second side portions 30, 32 laterally spaced from one another relative to the grip end 16 of the handle 12. The housing 28 further includes a frame 34 extending generally between the first and second side portions 30, 32. The first and second side portions 30, 32 each have a generally outwardly facing surface 36 defining an opening 38 for pivotably receiving the associated first projection 24 of the handle 12, and a curved channel 40 for slidably receiving the associated second projection 26 of the handle to permit pivoting of the razor cartridge 14 relative to the handle. The second projection 26 is preferably a curved segment shaped for mating with a corresponding portion of the curved channel 40. The slidable interaction between the second projection 26 and the curved channel 40 complements and increases stability to the pivoting action of the first projection 24 within the opening 38, and also provides predetermined angular limits to the pivoting action as explained more fully below. Although the first and second projections 24, 26 have been described and shown as part of the handle 12 and the openings or channels 38, 40 as part of the razor cartridge 14, the projections may alternatively form part of the razor cartridge and the openings or channels form part of the handle without departing from the scope of the present invention.

The first and second side portions 30, 32 each have a guard end 42, a cap end 44, a forward end 46 and a rearward end 48. The first and second side portions 30, 32 each define the associated opening 38 at a location adjacent to the forward end 46, and the curved channel 40 adjacent to the rearward end 48. Preferably, the first and second side portions 30, 32 each define the associated opening 38 at a location generally midway between the guard end 42 and the cap end 44. Moreover, the first and second side portions 30, 32 each define the associated curved channel 40 as extending between the guard end 42 and the cap end 44.

The handle 12 can further include a biasing member 50 interposed between the first and second arms 20, 22, and extending in a direction generally away from the grip end 16 of the handle 12 for engaging the razor cartridge 14 and pivotably biasing the razor cartridge toward a neutral pivot position relative to the handle. Preferably, the neutral pivot position is where the second projection 26 of the handle 12 is located about midway between longitudinal ends 52, 54 of the curved channel 40 so as to permit the razor cartridge 14 to pivot approximately equal angular distances in either direction away from the neutral pivot position.

For example, the biasing member 50 includes a resilient member having a first end 55 coupled to the handle 12, and a second end 56 coupled to a third projection 58 depending from a bottom of the frame 34. The third projection 58 includes a bearing surface 60, and the resilient member has a free end 62 pivotably urged against the bearing surface 60. The third projection 58 further defines a notch 64, and the resilient member includes a cross member 66. The cross member 66 is pivotably received within the notch 64 of the third projection 58.

In operation, the razor assembly 10 in accordance with the present invention follows the contours of a shaving surface. As the razor handle 12 moves relative to the shaving surface, the angle of the razor cartridge 14 changes relative to the handle in order to maintain the face of the cartridge generally planar with the shaving surface in contact with the cartridge. In other words, the razor assembly 10 establishes a generally continuous blade edge contact with the shaving surface during each shaving stroke. For example, if the angle of the razor handle relative to the shaving surface changes a maximum of 45 degrees in a counterclockwise direction, the orientation of the cartridge relative to the handle changes a maximum of 45 degrees in a clockwise direction, and vice versa.

Coupling the first and second arms 20, 22 to an external surface of the cartridge 14, instead of an internal surface, eliminates possible interference between the internal components of the cartridge and the first and second arms which could otherwise impede pivoting of the cartridge. The elimination of interference also permits greater flexibility in selecting at the design stage the location of a pivot axis of the cartridge relative to the handle. Moreover, coupling the first and second arms 20, 22 to an external surface of the cartridge 14 permits a larger channel to be defined by the cartridge for rinsing debris therefrom.

As mentioned hereinabove, a razor assembly in accordance with the present invention can be a permanent or a disposable assembly. A permanent assembly typically employs cartridges which are releasably attached to a razor handle. As shown in FIG. 4, for example, a razor assembly 110 provides for the interchange of cartridges. Like elements with the razor assembly 10 are labeled with like reference numbers preceded by the numeral one. The razor assembly 110 is similar to the razor assembly 10 except that the razor assembly 110 includes a release switch 170 for releasing a worn cartridge 114 from the handle 112, and for attaching a new cartridge to the handle.

In operation, the release switch 170 is slid or otherwise moved from an engagement position to a disengagement position to cause the first and second arms 120 and 122 to move away from the razor cartridge 114 to thereby release the razor cartridge from the handle 112. A new razor cartridge 114 is then interposed between the first and second arms 120, 122, and the release switch 170 is moved to the engagement position to cause the first and second arms 120, 122 to move toward and couple to the new razor cartridge.

As will be recognized by those of ordinary skill in the pertinent art, numerous modifications and substitutions may be made to the above-described embodiment of the present invention without departing from the scope of the invention as set forth in the appended claims. For example, although the razor assemblies 10 and 110 are shown and described with respect to unidirectional shaving, multidirectional shaving assemblies can be substituted without departing from the scope of the present invention. Moreover, the razor assemblies can be made to pivot in only one direction relative to the neutral pivot position. Accordingly, the preceding portion of this specification is to be taken in an illustrative, as opposed to a limiting sense.

1. A razor cartridge comprising:
a housing including first and second side portions, and a frame extending between the first and second side portions; and
at least one blade supported by the frame and extending generally between the first and second side portions; and
wherein each of the first and second side portions has an outwardly facing surface defining an opening for pivotably receiving an associated first projection of a razor handle, and a curved channel for slidably receiving an associated second projection of a razor handle to permit pivoting of the cartridge relative to the handle.

2. A razor cartridge as defined in claim 1, wherein the first and second side portions each have a guard end, a cap end, a forward end and a rearward end, and wherein the first and second side portions each define the associated opening at a location adjacent to the forward end, and the curved channel adjacent to the rearward end.

3. A razor cartridge as defined in claim 2, wherein the first and second side portions each define the associated opening at a location generally midway between the guard end and the cap end.

4. A razor cartridge as defined in claim 2, wherein the first and second side portions each define the associated curved channel as extending between the guard end and the cap end.

5. A razor cartridge as defined in claim 1, further including a projection depending from a bottom of the frame for being coupled to a razor handle.

6. A razor assembly comprising:
a handle including a cartridge end having first and second arms spaced from one another, each of the arms including first and second projections; and
a razor cartridge coupled to the cartridge end of the handle, including:
a housing including first and second side portions, and a frame extending between the first and second side portions; and
at least one blade supported by the frame and extending generally between the first and second side portions;
wherein each of the first and second side portions has an outwardly facing surface defining an opening for pivotably receiving an associated first projection of the razor handle, and a curved channel for slidably receiving an associated second projection of the razor handle to permit pivoting of the cartridge relative to the handle.

7. A razor assembly as defined in claim 6, wherein the first and second side portions each have a guard end, a cap end, a forward end and a rearward end, and wherein the first and second side portions each define the associated opening at a location adjacent to the forward end, and the curved channel adjacent to the rearward end.

8. A razor assembly as defined in claim 7, wherein the first and second side portions each define the associated opening at a location generally midway between the guard end and the cap end.

9. A razor assembly as defined in claim 7, wherein the first and second side portions each define the associated curved channel as extending between the guard end and the cap end.

10. A razor assembly as defined in claim 6, wherein the second projection of the razor handle is a curved segment shaped for mating with a corresponding portion of the curved channel.

11. A razor assembly as defined in claim 6, further including a biasing member coupled at one end to the handle and at another end to the cartridge so as to bias the cartridge to a predetermined neutral pivot position relative to the handle.

12. A razor assembly as defined in claim 11, wherein the neutral pivot position is where the second projection of the handle is located about midway between longitudinal ends of the curved channel so as to permit the cartridge to pivot approximately equal angular distances in either direction away from the neutral pivot position.

13. A razor assembly as defined in claim 6, further comprising:
a third projection depending from a bottom of the frame; and
a resilient member having a first end coupled to the handle and a second end coupled to the third projection so as to bias the cartridge to a predetermined neutral pivot position relative to the handle.

14. A razor assembly as defined in claim 13, wherein the third projection defines a bearing surface, and the resilient member has a free end pivotably urged against the bearing surface.

15. A razor assembly as defined in claim 14, wherein the third projection defines a notch, and wherein the resilient member is in the form of two arms converging toward the free end, the resilient member including a cross member connecting the two arms at the free end, and the cross member being pivotably received within the notch of the third projection.

16. A razor assembly as defined in claim 6, wherein the handle further includes a release switch movable between an engagement position and a disengagement position, the engagement position being for positioning the first and second arms relative to the cartridge such that the cartridge is coupled to the handle, and the disengagement position being for positioning the first and second arms relative to the cartridge such that the cartridge is released from the handle.
